(19) United States
(12) Patent Application Publication
(10) Pub. No.: US 2008/0092469 A1
(43) Pub. Date: Apr. 24, 2008

(54) ASSEMBLY LINE PLANT FOR PREFAB PANELS FOR WALLS OF BUILDINGS

(75) Inventors: Valente Carmine FRANCO, Villa Latina (IT); Peccolo MAURIZIO, Lugano (CH)

Correspondence Address: GREENBLUM & BERNSTEIN, P.L.C., 1950 ROLAND CLARKE PLACE, RESTON, VA, 20191, US

(73) Assignee: BIT TECHNOLOGIES LIMITED, Luxembourg (LU)

(21) Appl. No.: 11/843,469

(22) Filed: Aug. 22, 2007

(30) Foreign Application Priority Data
Aug. 23, 2006 (CH) 01347/06

(51) Int. Cl. B23P 11/00; E04B 1/02

(52) U.S. Cl. 52/251; 29/428

(57) ABSTRACT

Assembly line production plant and process for producing prefab panels. Assembly line production plant includes a plurality of individual assembly frames selectively openable and closable for assembling individual prefab panels, an opening station structured and arranged for opening the individual assembly frames, and first assembling and mounting station for assembling a first wall side of the panel. Assembly line production plant includes reinforcing iron station for supplying a reinforcing iron arrangement for the panel, second assembling and mounting station for assembling a second wall side, closing station structured and arranged for closing the individual assembly frames, filling station for filling a space between the first and second wall sides with cement mortar, maturing station for maturing the cement mortar, and plurality of individual trailers structured and arranged to transport the plurality of individual assembly frames. Each individual assembly frame is mountable to an individual trailer.

### CROSS-REFERENCE TO RELATED APPLICATIONS

The present application claims priority under 35 U.S.C. § 119 of Swiss Patent Application No. 01347/06, filed Aug. 23, 2006, the disclosure of which is expressly incorporated by reference herein in its entirety.

### BACKGROUND OF THE INVENTION

1. Field of the Invention

The present invention relates to an assembly line plant for producing prefab panels to form external and/or internal walls of buildings.

2. Background and Related Information

Production in stationary and also in mobile plants for prefab panels for private or public residential or industrial buildings (schools, hospitals, etc.) has seen a considerable technologic development over the past decades.

The engineers in particular aimed at rationalizing the production of the panels and at enlarging the field of their applications by proposing multi-layer panels for many different applications. Generally speaking, the rationalization efforts were concentrated on a specific item, i.e., namely to keep manufacturing cost of the panels as low as possible. Two approaches mainly were tried in order to reach this goal. The first practical approach was specialization on production of just a few types of different panels, or preferably on just one single type, in order to produce large series of the same product. In this manner the maximum degree of rationalization and thus of cost efficiency can be reached, but the flexibility of the plant accordingly is much reduced. Uniform panels imply monotony of the buildings realized, resulting in drearily uniform architecture, and the necessity of producing very large production volumes. These disadvantages are serious and predominantly affect the architect's freedom of creativity and create monotone suburban cityscapes found in many modern cities.

The other approach taken by the engineers is to realize versatile manufacturing plants for prefab panels, which are capable of producing the greatest number of panel types (with two or more layers, with insulation incorporated on one wall side or on both sides, in various dimensions and with different structural strength properties according to the application intended, etc.), plant adaptations being kept at a minimum. In this case the rationalization efforts thus were not aimed at production of large series of uniform panels but rather in the sense of creating manufacturing plants offering optimum conditions for adaptations to the characteristics of the panel to be produced. This optimization thus concerns entirely differing objectives, sometimes directly opposed to the ones of the first example described above.

A typical example of this second approach is disclosed in European patent application number EP-06405314.3 entitled “Fabbrica mobile per la fabbricazione di elementi prefabbricati (Mobile Production Plant for Producing Prefab Elements),” filed on Jul. 19, 2006, the disclosure of which is hereby expressly incorporated by reference in its entirety, in which a plant is described including a number of devices (assembly frames, equipment for preparation of reinforcing steel, concrete mixing plant, etc.) mounted on trailers or in containers that can be transported by road or by rail, in such a manner that the whole plant thus can be transported—as a mobile production plant—to the location where the prefab elements are required, together with a covering canopy, which also can be dismantled for transport. In this concept a mobile production plant is realized, in which the assembly frames are mounted each on a truck trailer to be moved to the various production stations along a substantially straight line. This concept, connected to the idea of producing the panels at the site where they will be used, and thus of saving transport costs, presents the disadvantage, however, that the versatility of the plant is quite limited, as the mobility of the plant limits the size of the plant and thus of the production capacity and the variety of the panel types that can be produced. In particular, the possibility of realizing a maturing or hardening station for the panels completed is not given; but this is an indispensable condition for increasing production capacity of a production plant. Thus, the mobile production plant according to this proposal is viable if settlements of more or less uniform prefab buildings are to be realized in remote areas (e.g., in desert areas or in hardly accessible mountain areas) where the problems of transporting prefab panels outweigh the ones of production capacity or versatility.

Concerning the types of panels to be realized, reference is made to another European patent application filed Feb. 13, 2006, under the number EP-06405065, the disclosure of which is hereby expressly incorporated by reference in its entirety, entitled “Elementi in laterizio per la costruzione di pannelli prefabbricati per l'edilizia (Elements of Brick Material for Realising Prefab Panels for the Building Trade),” which will be sufficient, and which patent application in turn represents an improvement over an earlier European patent application filed Jan. 8, 2003 under the number EP-1273729, the disclosure of which is also hereby expressly incorporated by reference in its entirety.

These documents give an idea of the various types of panels, and of their practical applications, which finally are to constitute the finished product of the production plant according to the present invention. An advantageous condition for achieving such great versatility is, above all, the possibility of adapting the assembly frames to the type of panel to be produced, or the availability of a sufficient number of specific assembly frames for the individual types of panels. Both possibilities are provided in the assembly line production plant according to the invention.

### SUMMARY OF THE INVENTION

Thus the present invention provides an assembly line production plant for prefab panels that permits production of large daily quantities of prefab panels of the most differing types, requiring a minimum of modifications of the devices forming the actual plant, thus overcoming the limitations implied by the mobility of the plant according to the above-discussed background information.

The present invention provides a predetermined throughput circulation path is established using which each assembly frame, after completion of the manufacturing cycle with the maturation phase, is brought back to the starting point of the circulation path, where the manufacturing cycle can start again, all of which is effected using simple transport systems permitting a fast work rhythm, rational for the personnel in charge.

The present invention provides an assembly line production plant for producing prefab panels for forming outside or internal walls of buildings, which can include a plurality of individual assembly frames, which can be opened and closed, for assembling the individual prefab panels. The invention also includes a station for opening the individual assembly frames, a first assembling and mounting station in horizontal position for assembling a lower wall side of the panel, a station for assembling a reinforcing iron arrangement in the panel, a second station in horizontal position for assembling an upper wall side, a closing station for the assembly frames, a station for filling the interspace between the two wall sides of the panel with cement mortar, and a maturing zone for maturing the cement mortar. Each assembly frame is mounted on a trailer transporting it successively from the opening station to the first assembling and mounting station for the lower wall side of the panel, to the assembly station for the installation of the reinforcing iron arrangement, to the second assembling and mounting station for assembly of the upper wall side of the panel, to the station for closing the assembly frame, to the maturing station for maturing the cement mortar, and wherein each assembly frame follows a predetermined circulation circuit that brings each assembly frame, after termination of the work cycle with the maturation phase, back to a starting point of a circulation circuit.

The assembly line production plant for producing prefab panels further includes a station for closing the assembly frame, and a station for filling in the cement mortar which coincide.

The invention is also directed to an assembly line production plant for producing prefab panels that includes a station for opening the assembly frame, a first station for assembling and mounting of the lower wall side of the panel, a station for installing the reinforcing iron arrangement, a second station for assembling and mounting of the upper wall side of the panel and a station for filling in the cement mortar. The stations are all arranged along a substantially straight line and are connected by a first rail track on which individual trailers carrying the individual assembly frames are transported. Access to the maturing zone is effected using a second rail track arranged at right angles with respect to the first rail track.

The assembly line production plant for producing prefab panels further includes a maturing zone equipped with at least one third rail track arranged parallel to the first rail track on which the assembly frames are transported during the preceding phases of production of the panels.

The assembly line production plant for producing prefab panels further includes a maturing zone for the cement mortar including a plurality of third rail tracks and that within the maturing zone are at least one assembly frame in their maturing phase. The production time corresponds to the time duration required for ensuring maturation of the first panel produced during a complete work cycle.

The assembly line production plant for producing prefab panels further includes: a number of assembly frames which have circulating ranges from approximately 12 units to approximately 60 units.

The assembly line production plant for producing prefab panels further includes a transfer of the transporting trailer of each assembly frame from the first rail track to the second rail track, from the second rail track to the third rail track of the maturing zone, and from the third rail track back to the first rail track is effected using direction change devices that can change the transporting direction of the assembly frames by 90°.

The assembly line production plant for producing prefab panels further provides individual assembly frames with devices facilitating adaptation, in particular to the thickness, of the type of panel to be produced.

The assembly line production plant for producing prefab panels further provides different sizes of assembly frames are used in the plant for producing specific types of panels.

The present invention is directed to an assembly line production plant for producing prefab panels. The assembly line production plant includes a plurality of individual assembly frames that are selectively openable and closable for assembling individual prefab panels, an opening station structured and arranged for opening the individual assembly frames, and a first assembling and mounting station for assembling a first wall side of the panel. The assembly line production plant also includes a reinforcing iron station for supplying a reinforcing iron arrangement for the panel, a second assembling and mounting station for assembling a second wall side, a closing station structured and arranged for closing the individual assembly frames, a filling station for filling a space between the first and second wall sides with cement mortar, a maturing station for maturing the cement mortar, and a plurality of individual trailers structured and arranged to transport the plurality of individual assembly frames. Each individual assembly frame is mountable to an individual trailer.

According to a feature of the invention, the individual assembly frames can be successively transported from the opening station to the first assembling and mounting station to the reinforcing station to the second assembling and mounting station. The can further be successively transported from the second assembling and mounting station to the closing station to the filling station to the maturing station. Further, the closing station and the filling may be formed as a single station, and the individual assembly frames may be successively transported from the second assembling and mounting station to the single station to the maturing station.

In accordance with another feature of the instant invention, the stations may be arranged along a circulation circuit, such that a work cycle of the circulation circuit begins and ends at the opening station.

According to the present invention, the prefab panels may be positionable for forming outside or internal walls of buildings.

In accordance with another feature of the invention, in an open position, the individual assembly frames can include a horizontally oriented portion on which the first wall side of the panel may be arranged in the first assembling and mounting station.

According to still another feature of the invention, the second wall side of the panel can be arranged horizontally above the first wall side of the panel.

Still further, the closing station and the filling station can be formed as a single station.

Moreover, the circulation circuit can include a substantially straight portion composed of a first rail track and a second portion composed of a second rail track arranged essentially perpendicular to the first track. The plurality of trailers can be structured to traverse the first rail track to transport the individual assembly frames from the opening station to the filling station, and the maturing station may be accessed by the second rail track. The second portion can further include an at least one third rail track arranged in the maturing station essentially parallel to the first rail track. The at least one third rail track may include a plurality of third rail tracks, and each individual assembly frame may be located in the maturing station for a time duration for ensuring maturation of a panel formed in a respective one of the individual panels that corresponds to a time duration of the work cycle.

According to another feature of the invention, the plurality of individual assembly frames may include between 12 units to 60 units.

According to another feature, the present invention can further include direction change devices structured to change a transporting direction of the individual assembly frames by 90° and arranged to couple the first rail track to the second rail track, to couple the second rail track to the at least one third rail track, and to couple the at least one third rail track to the first rail track.

Further, the individual assembly frames may include devices to facilitate adaptation of a type of panel to be produced. The devices to facilitate adaptation can be structured and arranged to adapt to a thickness of the panel to be produced.

In accordance with still yet another feature of the present invention, the individual assembly frames can be of different sizes for producing different types of panels.

The present invention is directed to a process for producing prefab panels. The process includes mounting a selectively openable and closable individual assembly frame on a trailer, and transporting the trailer along a predefined path that begins and ends with opening the individual assembly frame. Further, along the predefined path, the process further includes assembling a first wall side of the panel on a portion of the opened individual assembly frame, supplying a reinforcing arrangement, assembling a second wall side of the panel, closing the individual assembly frame, filling a space between the first and second wall sides with cement mortar, and curing the cement mortar.

The instant invention is directed to a prefab panel for one of an interior or exterior wall of a building produced by a process including mounting a selectively openable and closable individual assembly frame on a trailer, and transporting the trailer along a predefined path that begins and ends with opening the individual assembly frame. Along the predefined path, the process further includes assembling a first wall side of the panel on a portion of the opened individual assembly frame, supplying a reinforcing arrangement, assembling a second wall side of the panel, closing the individual assembly frame, filling a space between the first and second wall sides with cement mortar, and curing the cement mortar.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of preferred embodiments of the present invention, in which like numerals represent like elements throughout the several views of the drawings unless otherwise noted, and wherein:

FIG. 1 illustrates a top view and a side view of an inventive plant with three stations, where the elements of the panels are assembled in the assembly frames, one station where the assembly frames are opened and one, where they are closed and filled, and 24 stations where the cement mortar is allowed to mature;

FIG. 2 illustrates a section along the line A-A depicted in FIG. 1, showing the opening station for the assembly frames;

FIG. 3 illustrates a section along the line B-B depicted in FIG. 1, showing the assembly station for the elements (brick material or tile material plates) forming the panel;

FIG. 4 illustrates a section along the line C-C depicted in FIG. 1, showing the closing station for the assembly frames and for filling the cement mortar into the closed assembly frame;

FIG. 5 illustrates a section along the line D-D depicted in FIG. 1, showing the transport of a closed assembly frame towards the maturing zone for maturing the cement mortar;

FIG. 6 illustrates a top view (lay-out) of the trailer transporting the panel, with one wall of the assembly frame in horizontal position and the other one in vertical position; and

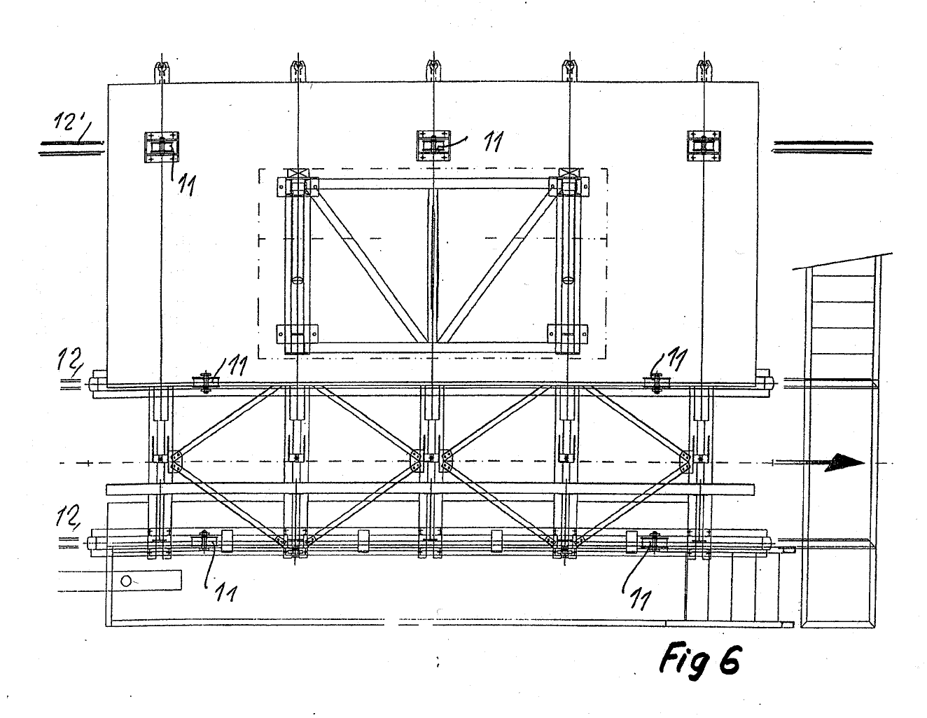

FIG. 7 illustrates a detail of the device used for changing the transport direction of the assembly frames between the actual assembly zone to the maturing zone, and from the maturing zone to the opening and unpacking station, and to the return of the assembly frames to the assembly zone respectively.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

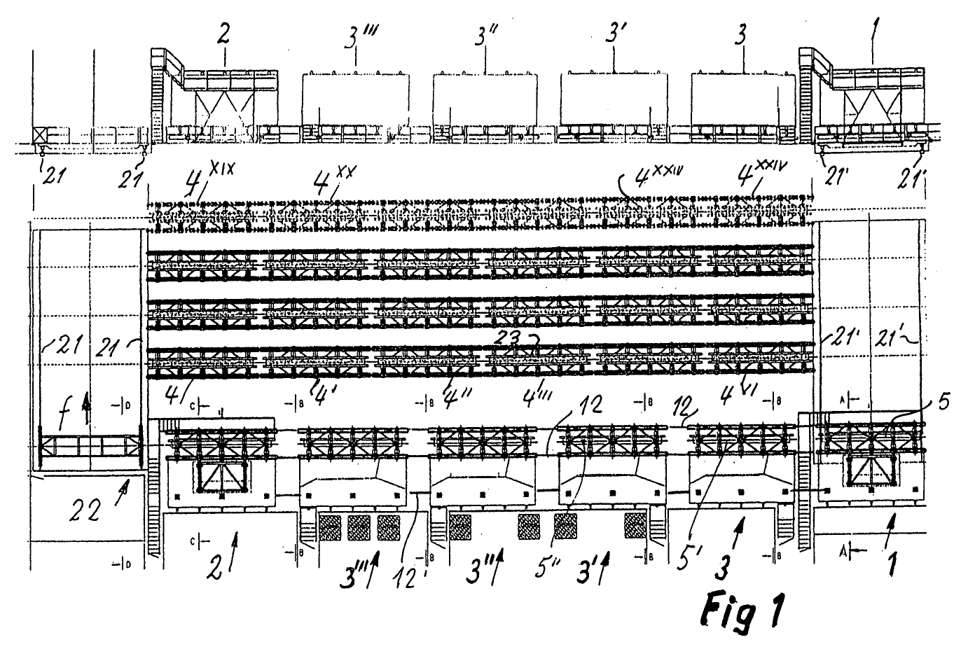

In FIG. 1 an example is shown—in a top view and in a side view—of a plant according to the present invention, comprising a station 1 for opening assembly frames 5, a station 2 for closing and filling the assembly frames with cement mortar, four stations 3, 3′, 3″, 3′″ for assembling and mounting elements forming the panel, and 24 stations 4-4^{xxlv} for cement mortar maturing or hardening.

The number of stations 3, 3′ . . . 3ⁿ for assembling and mounting elements forming the finished panel, illustrated in the example in FIG. 1 with four stations, can vary according to the type of panels to be produced in the planned plant. The higher the number of stations for assembling and mounting, the greater the flexibility of the production plant can be. Actually with a greater number of stations for assembling and mounting it is easier to provide more or less “specialized” stations for realizing determined operations, in such a manner that e.g., stations can be provided, which are suitable for producing panels of one predetermined total thickness without being forced to adapt the settings of the devices on the frame. A reduced number of stations for assembling and mounting however, implies reduced versatility of the plant, and that for producing different types of panels, adaptations and adjustments of settings will be required of the devices on the station, which reduces the productivity of the plant and causes higher production costs.

In contrast to the above-noted processes, such as, e.g., EP-06405314.3, the individual assembly frames 5, . . . 5ⁿ (visible in the FIG. 1 on the various work stations 1 through 4) are mounted on trailer 6, to be successively transported to station 1 for opening, to first station 3 for assembling and mounting the lower side wall of the panel, to second station for assembling and mounting of the reinforcing irons, to second station 3″ for assembling and mounting of upper side wall of the panel, to station 3′″ for closing of the assembly frame, to station 2 for filling in, and to the zone of stations 4 . . . 4ⁿ for maturing the cement mortar. Assembly frame 5 on the trailer 6 rolling on suitable rail tracks follows a predetermined circuit that brings each assembly frames 5 . . . 5′, after completion of the working cycle with the maturing phase, back to the starting point of the circuit, i.e., to station 1, where the assembly frame is opened and the finished panel is lifted off. After a possible cleaning process of the opened assembly frame (that can be effected, e.g., at position 1 for opening assembly frame 5, or at one of the first positions 3 for assembly and mounting), the lower side wall of a new panel is assembled and mounted.

In particular, the terms lower wall side or upper wall side of the panel are understood to refer only to the position of the panel during the manufacturing process, but not to the position the panel is to take once it is installed in a building. Thus, the lower side wall thus can become, in the building, the outer wall surface or an inside wall surface of the building, where its construction (e.g. the location of the reinforcing bars or of the thermal insulation material) is to take the final destination of the wall into account.

The system of rail tracks on which the trailers 6 with the assembly frames 5 . . . 5ⁿ will be explained in more detail in the following with reference to the illustrations.

It is to be understood the features of the present invention can be combined with a mobile production plant, such as disclosed by EP-06405314.3. In this regard, if the basic idea of the present invention, i.e., the circulation of the assembly frames on transporting trailers, is combined with the one of the mobile production plant, considerable concessions are to be made with respect to the flexibility and versatility of the production plant, as already mentioned above. But the two concepts are not colliding and thus can be combined.

In some embodiments of the invention, which are not shown here in detail, it should be readily understood the station for closing assembly frame 5 can coincide with the one for filling in the cement mortar. Thus, while these operations can be effected at two separate stations, it is likewise understood that, once assembly frame 5 is closed and its walls are secured, it is ready for the filling in of the cement mortar, which thus can be effected “in loco,” provided that the devices required are at hand, without transporting the assembly frame. This solution permits saving one work station, but the operation rhythm may be slowed as two operations are to be effected at just one single station. This solution thus is adopted only where it permits real optimization of the working cycle, in consideration of the minimum duration of stay at the work stations preceding the station for closing.

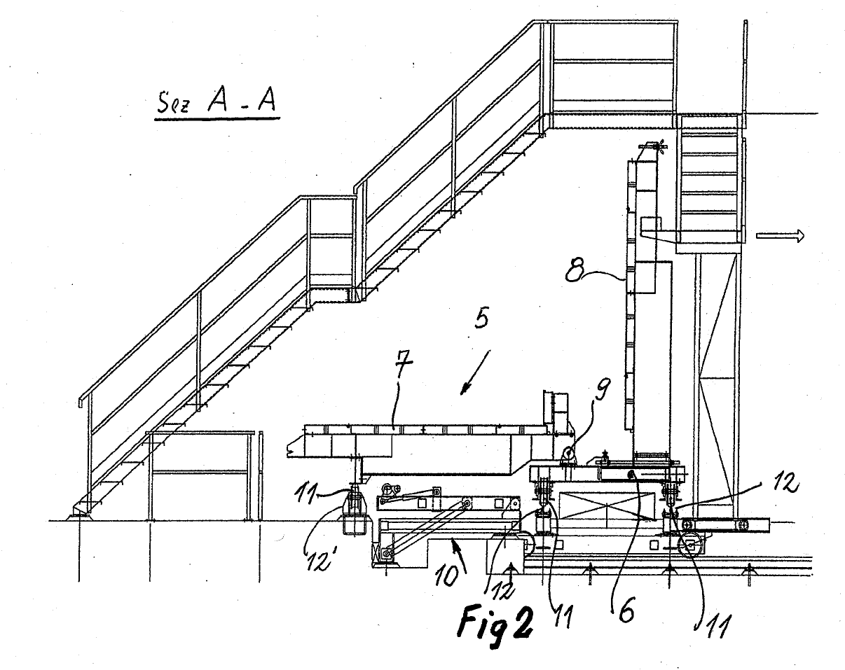

While FIG. 1 illustrates the stations according to the invention and the position of assembly frame 5 at each station, FIGS. 2-5 depict more detailed views of these stations. Thus, in the following, FIGS. 2-5 will be described which correspond to the sections along the lines A-A, B-B, C-C and D-D, respectively, shown the FIG. 1, which represent cross-sections along the work stations being illustrated in the sense of mere examples of embodiments, not exhausting all possibilities of realizing such work stations. One having ordinary skill in the art would know the problem of opening and cleaning the assembly frames, the assembly and mounting of the elements (brick material, reinforcing bars, etc.) on one wall of the assembly frame held in horizontal position, closing the assembly frame for forming, together with the other wall in vertical position, the inter-space taking up the cement mortar. These operations are known in practice in the production of prefab walls and prefab panels and can be performed using various types of different devices, even if they seem quite similar. The system shown of an assembly frame that can be opened is not essential within the scope of the present invention. Further, the invention is directed to the transport of the opened and closed assembly frames along a predetermined circulation circuit.

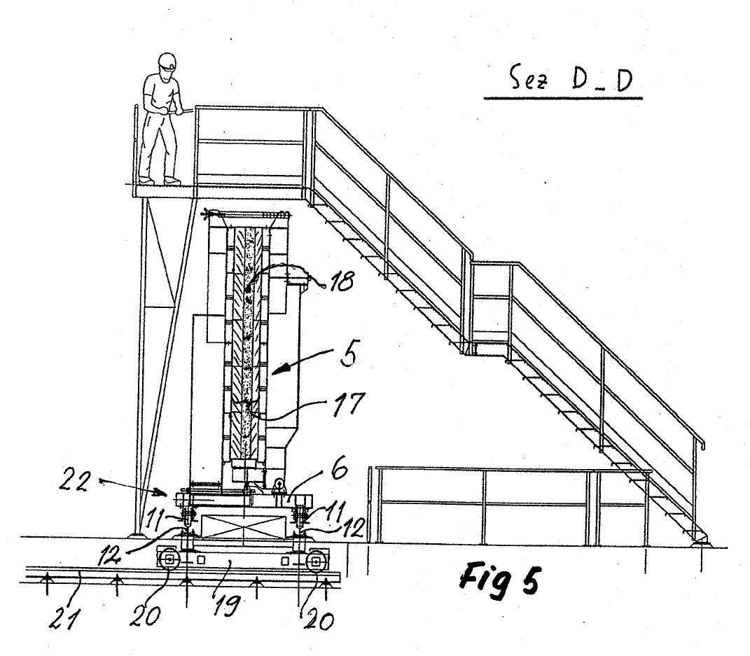

In FIG. 2 a section along the line A-A in FIG. 1 is given, showing the station for opening assembly frames 5 . . . 5ⁿ. A horizontal wall 7 and a vertical wall 8 of the assembly frame 5 are indicated. Open horizontal wall 7 is hinged in a point using a hinge link 9 which permits an upward pivoting movement up to a closed position of the assembly frame 5 (visible in the FIG. 5). For this purpose a lifting mechanism 10 for wall 7 is provided, comprising a number of levers and pistons. All this corresponds to the normal knowledge of the specialist in the field, and thus need not be explained in detail here. Transporting trailer 6 is equipped with wheels 11 rolling on rail tracks 12, 12′ arranged along the whole tract connecting the station 1 for opening with station 2 for filling the assembly frames. Three rails 12, 12′ are provided, namely two sustaining the trailer proper, and one (12′) (shown at the left hand side in the FIG. 2) for sustaining the free end of opened wall 7 of assembly frame 5, which otherwise would be cantilevered and thus be guided insufficiently. The position and the number of rails 12, 12′ and of wheels 11 can vary according to the requirements and as such, any position and number of rails is contemplated by the present invention. It just is important that the assembly frame can be moved in its opened state (one of its walls being cantilevered) along a predetermined circuit, preferentially rectilinear, between the position for opening and the position for closing and/or filling the assembly frame with cement mortar.

At the station shown in FIG. 2, the assembly frame can be opened and the finished panel can be lifted off, and cleaning of the assembly frame can be provided.

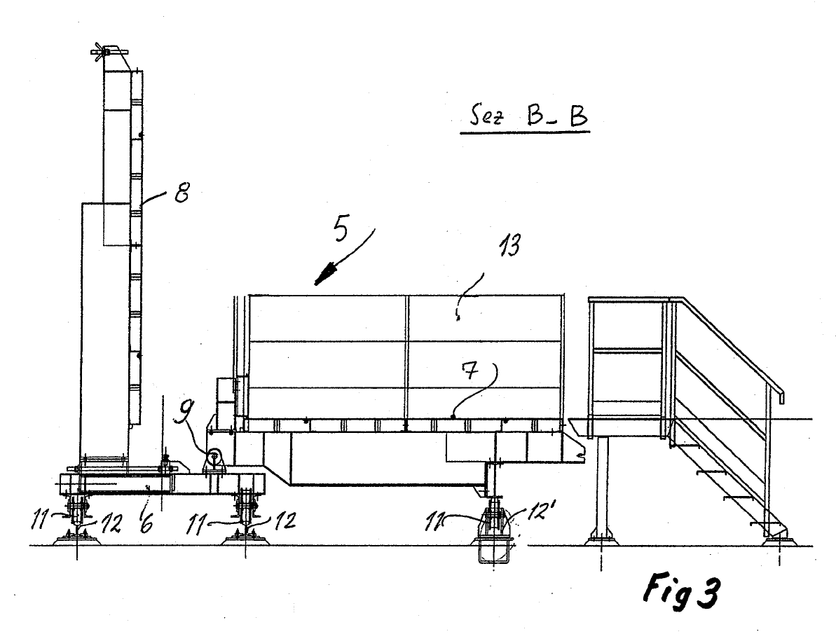

FIG. 3 represents a section along the line B-B of the FIG. 1, in which the phase of assembly of and mounting of elements of the panels is illustrated. These elements can constitute the lower wall side of the panel once it is finished, and can include a layer of brick material elements or elements of insulation, e.g., polystyrol, or the reinforcing irons, none of which are shown in this Figure. But it is shown how provisional protecting devices are applied as safety elements for the personnel.

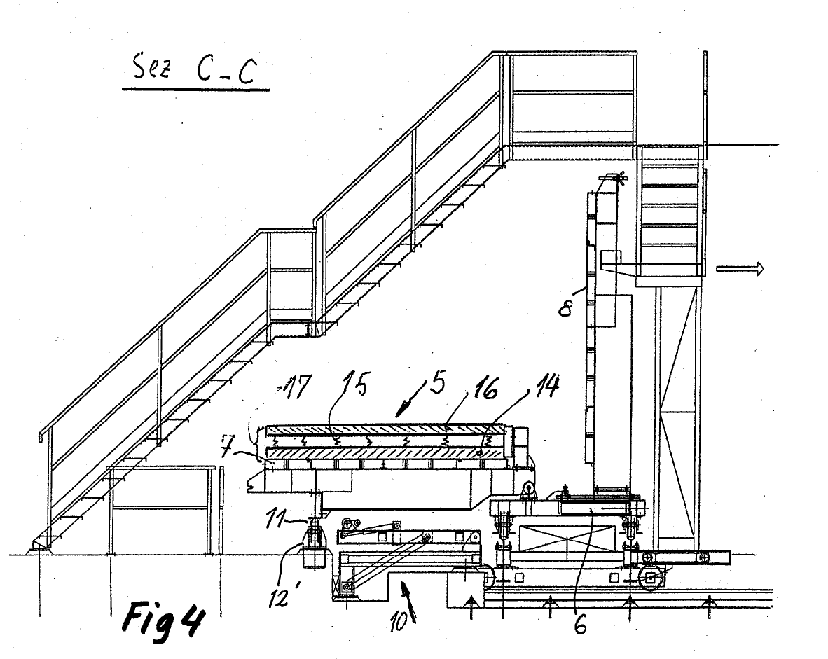

In FIG. 4, a section along the line C-C of the FIG. 1 is shown, illustrating trailer 6 in its position for closing assembly frame 5, which here is shown still in its opened state. The lower layer of elements of the panel is visible, designated 14, reinforcing irons 15 (indicated summarily), and upper layer 16 of the panel resting on the reinforcing irons arrangement. Lower layer 14 and upper layer 16 of panel 17 can include brick material or slate plates, of insulation, e.g., polystyrol, or of insulating materials (e.g. also of wood). The height of panel 17 generally can be variable, but it is to be taken into account when setting hinge link 9 on the fixed vertical wall of assembly frame 5.

In FIG. 5, closed assembly frame 5 is shown from the side opposed to the one shown in the FIG. 4, with cement mortar 18 already filled into the inter-space between two layers 14 and 16 of panel 17. The filling operation was effected either at the station for closing assembly frame 5 or at a combined station for closing and filling.

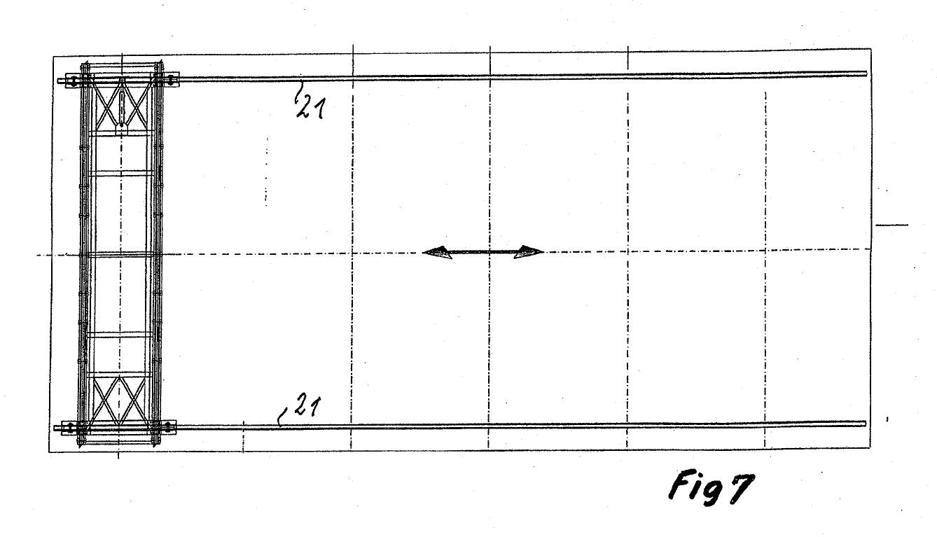

In FIG. 5, it can be seen how transporting trailer 6 for assembly frame 5 is moved along rail track 12 onto a trailer 19 equipped with wheels 20 (two wheels per side) rolling on two rails 21 arranged at 90° with respect to rail track 12, 12′ of trailer 6. In other words, at the end of the manufacturing track of the panels, extending between station 1 for opening and the station 2 for closing assembly frames 5, a device 22 for changing the direction is provided, which permits modification of the direction of trans-port of the assembly frames 5 by 90°. This direction changing device 22 can be realized in various types, of which the one shown in FIGS. 5 and 7 represent a convenient example, but not the only one possible. In the arrangement shown, two of rails 12 that guide the trailer 6 of assembly frame 5 (third rail 12′ sustaining the lower portion of the assembly frame no longer is required after the assembly frame has been closed) are prolonged and end on transporting trailer 19 with wheels 20 arranged to roll on track 21 extending at right angles with respect to track 22.

Trailer 6 on which assembly frame 5 has been transported thus can be moved in the direction of arrow f (FIG. 1) until it reaches one of several parallel rail tracks (four of which are shown in the FIG. 1) on which trailers 6 are “threaded in,” using a system of the same type as described under 22, to maturing zone 4 which can include a greater number of trailers with assembly frames. In FIG. 1, on each of the rail tracks of maturing zone 4, six trailers 6 find room and a total of, e.g., four parallel tracks are shown, the maturing zone 4 (understood as the totality of maturing stations 4 through 4^{xxlv}) can take up, in the case illustrated, two assembly frames 5 for maturing. The total number of assembly frames in maturation can vary considerably depending on the requirements of the production of the plant, where according to a preferred realization of the present invention a total number of assembly frames 5 in circulation (comprising the assembly frames in the phases of manufacture and the ones in their maturing phase) can vary between a minimum of 12 (in which case only one rail track is provided in maturing zone 4 parallel to rail track 12) and a maximum of 60 units. The maximum number is given, essentially, other than for reasons of logistics, by the time span required for maturation of the cement mortar in assembly frame 5 before it can be opened. It would not make sense to keep the finished and matured panel longer in closed assembly frame 5.

At the other end of maturing zone 4, i.e., represented in the FIG. 1 at the right hand side, a second direction change device with rails 21′ is provided, laid out and functioning in the same manner as changing device 22, and thus does not require further description here. Using this direction change device the assembly frames with the matured panels can be transported to station 1 for opening, where they are opened and the finished panels are taken off and transported to the building site to be installed there.

In this manner the work cycle is completed, which according to the present invention provides that assembly frames 5 follow a predetermined circulation circuit leading them from opening station 1 back to the point of opening of assembly frame 5 again.

According to some embodiments, as described above, that the plant is equipped with a plurality of third rail tracks 23 (in FIG. 1, e.g., four of them are provided) and that in maturing zone 4 simultaneously at least one assembly frame 5 in their maturing phase find room, (the production time of) which corresponds to the time duration required for maturing the cement mortar of the first panel produced during a production cycle. In other words, maturing zone 4 offers as many stations for maturing as are needed for the duration required for maturing the cement mortar of the first panel produced during a production cycle (which also can be of 24 hours, corresponding to non-stop production, before the next production cycle begins), which thus begins with the opening of the first panel mentioned and the production of the successive production cycle. In this manner best use is made of maturing zone 4 of optimized surface area. A maturing zone of lower capacity would imply reduced production capacity of the whole plant and would cause time losses.

According to some embodiments of the present invention, it is provided that individual assembly frames 5 are equipped with devices (as indicated in the Figures, but possibly realized in various types that the specialist in the field can apply) for facilitating adaptation of assembly frame 5 to the type of panel to be produced, in particular to the thickness of the panel, that can vary from a few centimeters, e.g., 15 cm and up to between 40 and 50 cm.

According to some embodiments of the production plant, it is provided that in the plant different types of assembly frames 5 are used simultaneously, each of which is adapted to produce a specific type of panel. In this context particularly sandwich type panels are thought of, with two wall sides of brick material, or insulating panels with one wall side of brick material and one of insulation, e.g., polystyrol, etc.

In some embodiments, it can prove favorable, instead of using universal assembly frames 5, the settings of which can be adapted, to choose specific assembly frames that are less costly and easier to handle. This option however, tends to increase the number of assembly frames present in a production plant. This, ultimately, is a problem of economic convenience. However, such configurations are contemplated by the present invention.

The advantages offered by the present invention have been amply discussed in the course of the description and thus need not to be explained again herein.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

Further, when an amount, concentration, or other value or parameter, is given as a list of upper preferable values and lower preferable values, this is to be understood as specifically disclosing all ranges formed from any pair of an upper preferred value and a lower preferred value, regardless whether ranges are separately disclosed.

### LIST OF REFERENCE NUMERALS

1 station for opening the assembly frames
2 station for closing and/or filling the assembly frames
3, 3′, 3″, 3′″ station for assembling and mounting
4 maturing zone for the cement mortar
4′ . . . 4^{xxlv} maturing station for the cement mortar
5 . . . 5ⁿ assembly frame
6 transporting trailer
7 open (horizontal) wall of the assembly frame 5
8 vertical wall of the assembly frame 5
9 linking hinge
10 lifting mechanism
11 wheels of the trailer 6
12 rail track
13 temporary protecting devices
14 lower wall side of the panel
15 reinforcing iron arrangement
16 upper side wall of the panel
17 panel
18 cement mortar
19 transporting trailer
20 transporting wheels
21 rail track
22 direction change device
23 third rail track

What is claimed:

1. An assembly line production plant for producing prefab panels, comprising:
a plurality of individual assembly frames that are selectively openable and closable for assembling individual prefab panels;
an opening station structured and arranged for opening the individual assembly frames;
a first assembling and mounting station for assembling a first wall side of the panel;
a reinforcing iron station for supplying a reinforcing iron arrangement for the panel;
a second assembling and mounting station for assembling a second wall side;
a closing station structured and arranged for closing the individual assembly frames;
a filling station for filling a space between the first and second wall sides with cement mortar;
a maturing station for maturing the cement mortar; and
a plurality of individual trailers structured and arranged to transport the plurality of individual assembly frames, wherein each individual assembly frame is mountable to an individual trailer.

2. The assembly line production plant in accordance with claim 1, wherein the individual assembly frames are successively transported from the opening station to the first assembling and mounting station to the reinforcing station to the second assembling and mounting station.

3. The assembly line production plant in accordance with claim 2, wherein the individual assembly frames are further successively transported from the second assembling and mounting station to the closing station to the filling station to the maturing station.

4. The assembly line production plant in accordance with claim 2, wherein the closing station and the filling are formed as a single station, and the individual assembly frames are further successively transported from the second assembling and mounting station to the single station to the maturing station.

5. The assembly line production plant in accordance with claim 1, wherein the stations are arranged along a circulation circuit, such that a work cycle of the circulation circuit begins and ends at the opening station.

6. The assembly line production plant in accordance with claim 1, wherein the prefab panels are positionable for forming outside or internal walls of buildings.

7. The assembly line production plant in accordance with claim 1, wherein, in an open position, the individual assembly frames include a horizontally oriented portion on which the first wall side of the panel is arranged in the first assembling and mounting station.

8. The assembly line production plant in accordance with claim 1, wherein the second wall side of the panel is arranged horizontally above the first wall side of the panel.

9. The assembly line production plant in accordance with claim 1, wherein the closing station and the filling station are formed as a single station.

10. The assembly line production plant in accordance with claim 5, wherein the circulation circuit comprises:
a substantially straight portion composed of a first rail track; and
a second portion composed of a second rail track arranged essentially perpendicular to the first track.

11. The assembly line production plant in accordance with claim 10, wherein the plurality of trailers are structured to traverse the first rail track to transport the individual assembly frames from the opening station to the filling station, and the maturing station is accessed by the second rail track.

12. The assembly line production plant in accordance with claim 11, wherein the second portion further includes an at least one third rail track arranged in the maturing station essentially parallel to the first rail track.

13. The assembly line production plant in accordance with claim 12, wherein the at least one third rail track comprises a plurality of third rail tracks, and each individual assembly frame is located in the maturing station for a time duration for ensuring maturation of a panel formed in a respective one of the individual panels that corresponds to a time duration of the work cycle.

14. The assembly line production plant in accordance with claim 1, wherein the plurality of individual assembly frames comprises between 12 units to 60 units.

15. The assembly line production plant in accordance with claim 12, further comprising direction change devices structured to change a transporting direction of the individual assembly frames by 90° and arranged to couple the first rail track to the second rail track, to couple the second rail track to the at least one third rail track, and to couple the at least one third rail track to the first rail track.

16. The assembly line production plant in accordance with claim 1, wherein the individual assembly frames comprise devices to facilitate adaptation of a type of panel to be produced.

17. The assembly line production plant in accordance with claim 16, wherein the devices to facilitate adaptation are structured and arranged to adapt to a thickness of the panel to be produced.

18. The assembly line production plant in accordance with claim 1, wherein the individual assembly frames can be of different sizes for producing different types of panels.

19. A process for producing prefab panels, comprising:
mounting a selectively openable and closable individual assembly frame on a trailer;
transporting the trailer along a predefined path that begins and ends with opening the individual assembly frame; and
along the predefined path, the process further comprises:
assembling a first wall side of the panel on a portion of the opened individual assembly frame;
supplying a reinforcing arrangement;
assembling a second wall side of the panel;
closing the individual assembly frame;
filling a space between the first and second wall sides with cement mortar; and
curing the cement mortar.

20. A prefab panel for one of an interior or exterior wall of a building produced by a process comprising:
mounting a selectively openable and closable individual assembly frame on a trailer;
transporting the trailer along a predefined path that begins and ends with opening the individual assembly frame; and
along the predefined path, the process further comprises:
assembling a first wall side of the panel on a portion of the opened individual assembly frame;
supplying a reinforcing arrangement;
assembling a second wall side of the panel;
closing the individual assembly frame;
filling a space between the first and second wall sides with cement mortar; and
curing the cement mortar.
